(19) United States
(12) Patent Application Publication
(10) Pub. No.: US 2022/0150578 A1
(43) Pub. Date: May 12, 2022

(54) SYSTEM AND METHOD FOR PROVIDING A UNITARY INTERNET-OF-THINGS INTERFACE VIA A MEDIA GATEWAY APPLIANCE

(71) Applicant: ARRIS ENTERPRISES LLC., Suwanee, GA (US)

(72) Inventors: Michael Francis Rzucidlo, Media, PA (US); Albert Fitzgerald Elcock, West Chester, PA (US)

(73) Assignee: ARRIS ENTERPRISES LLC., Suwanee, GA (US)

(21) Appl. No.: 17/504,707

(22) Filed: Oct. 19, 2021

Related U.S. Application Data
(60) Provisional application No. 63/110,412, filed on Nov. 6, 2020.

(51) Int. Cl. H04N 21/436; H04N 21/41; H04N 21/478

(52) U.S. Cl. CPC H04N 21/43615; G16Y 10/80; H04N 21/478; H04N 21/4131

(57) ABSTRACT

A system and method for enabling and supporting the use of a single user interface to monitor and control multiple IoT systems or devices. The system utilizes displays, interfaces and pointing devices (television remote controls, television screens, smart phones) that are familiar to a significant population of prospective users, and enables aggregation supporting the control/monitoring of multiple, disparate IoT systems via a single device/interface.

### CROSS-REFERENCE TO RELATED APPLICATION

This application claims the benefit of U.S. Provisional Patent Application 63/110,412, filed Nov. 6, 2020, which is incorporated by reference herein in its entirety.

### BACKGROUND OF THE INVENTION

The proliferation of residential appliances and systems linked to both local networks and/or the internet has greatly increased in recent years. These “smart” devices are often referred to as comprising the “Internet-of-Thing” (“IoT”). IoT devices include cameras, door locks, lighting systems, refrigerators, heating/ventilation systems, etc. Typically, each of these systems is adapted to be controlled and/or provide information via a user-interface accessed through an application or program residing on a smartphone, tablet or computer. The link between the user-interface device and the smart device being supported by a local network or the internet (or both). Each of these applications or programs is typically limited to providing a user-interface that interacts with only one type of IoT device or system. For example, the program providing a user-interface to interact with a lighting system in a residence would typically not permit a user to interact with the door locks or the heating/ventilation system associated with that residence.

Recent years have also seen the provision of broadband residential services expand around the globe, with more multiservice operators (“MSOs”) offering an ever-increasing menu of media and communication options to their residential and business customers. Typically, these broadband services are provided via a cable, optical or satellite broadband connection that links to a media gateway appliance (“MGA”) at the residence or business location. The MGA performs a host of functions including modulation/demodulation, packetizing and tuning to support and provide bidirectional multimedia communications and services. The MGA typically serves as the nexus for the routing of broadband media, information and services in a given residence. An example of one type of MGA is a set-top box, providing a user-friendly interface (typically utilizing a television screen and a hand-held remote-control unit) through which users can access and interact with numerous sources and services via a broadband network connection. These would include Internet-accessed streaming services, network television, on-demand programming, etc.

Given that an increasing number of IoT devices being installed in residential environments, a user may find themselves needing to access multiple programs and applications in order to monitor of control all of the IoT devices. Some IoT device interfaces may be supported by a program on a computer, others on a smartphone or tablet application. Multiple user-interface devices may need to be accessed by a user in order to control the IoT devices in a residence. This can result in a situation where IoT management becomes cumbersome and inconvenient. It would be advantageous to provide a single user-interface that permitted a user to access all of the IoT devices connected to a particular network and/or located within a particular residence. Ideally, such an interface should be accessible via a familiar, user-friendly interface, such as an MGA, smartphone or tablet.

### BRIEF SUMMARY OF THE INVENTION

A system and method for enabling and supporting the use of a single user interface to monitor and control multiple IoT systems or devices. The system utilizes displays, interfaces and pointing devices (television remote controls, television screens, smart phones) that are familiar to a significant population of prospective users, and enables aggregation supporting the control/monitoring of multiple, disparate IoT systems via a single device/interface.

### BRIEF DESCRIPTION OF THE DRAWINGS

The aspects, and advantages of the present invention will become better understood with regard to the following description, appended claims, and accompanying drawings in which:

FIG. 1 is a functional block diagram of a first embodiment of a system adapted to enable the control of multiple IoT systems.

FIG. 2A is a depiction of a user interface display adapted to be utilized with the system of FIG. 1, wherein the display is in a first state.

FIG. 2B is a depiction of a user interface display adapted to be utilized with the system of FIG. 1, wherein the display is in a second state.

FIG. 2C is a depiction of a user interface display adapted to be utilized with the system of FIG. 1, wherein the display is in a third state.

FIG. 3 is a flow diagram of a process supported by the system FIG. 1

FIG. 4 is a functional block diagram of a second embodiment of a system adapted to enable the control of multiple IoT systems.

### DETAILED DESCRIPTION

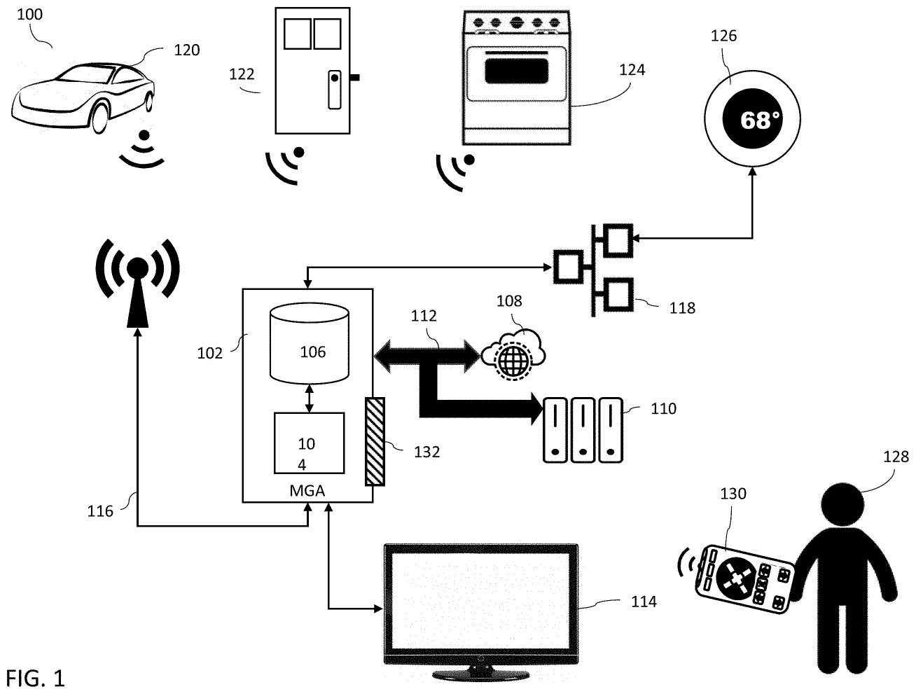

FIG. 1 is a functional diagram of a first preferred embodiment of a system (100) adapted for the provision of a single user-interface for interacting, monitoring and controlling multiple, dissimilar IoT devices connected to a given local network. As shown, MGA (102) includes processor 104 and memory 106. MGA 102 is also shown to be linked to the Internet (108) via and to MSO headend 110 via a broadband link (112). Television 114 is also shown to be linked to MGA 102, as is wireless network 116 (for example, this network could be an 802.11 Wi-Fi network) and wired network 118 (an example of which would be an Ethernet network). FIG. 1 also depicts four independent IoT devices/systems: automobile control system 120, door lock 122, oven control system 124, and thermostat 126. As shown, automobile control system 120, door lock 122, and oven control system 124 are linked to MGA 102 via wireless network 114. Thermostat 126 is shown to be linked to MGA 102 via wired network 118.

System 100 is adapted to enable a user (128) to selectively interface, interact and/or control the networked IoT devices and systems utilizing MGA 102, remote-control 130 and television 114. MGA 102 includes a wireless receiver (132) adapted to receive wireless control signals generated by remote-control 130. These control signals can be optical, ultrasonic or radio frequency. In support of this functionality, memory 106 stores data indicative of each of the networked IoT devices/systems, including information that can be utilized by processor 104 to interpret information received from and generate control commands intended for each of the networked IoT devices/systems. Memory 106 also stores information that can be utilized by processor 104 to generate user-interface graphic screens upon television 114, including a screen displaying multiple icons, each of which represents a particular networked IoT device/system, and at least one screen dedicated to interacting or controlling each of the networked IoT devices/systems.

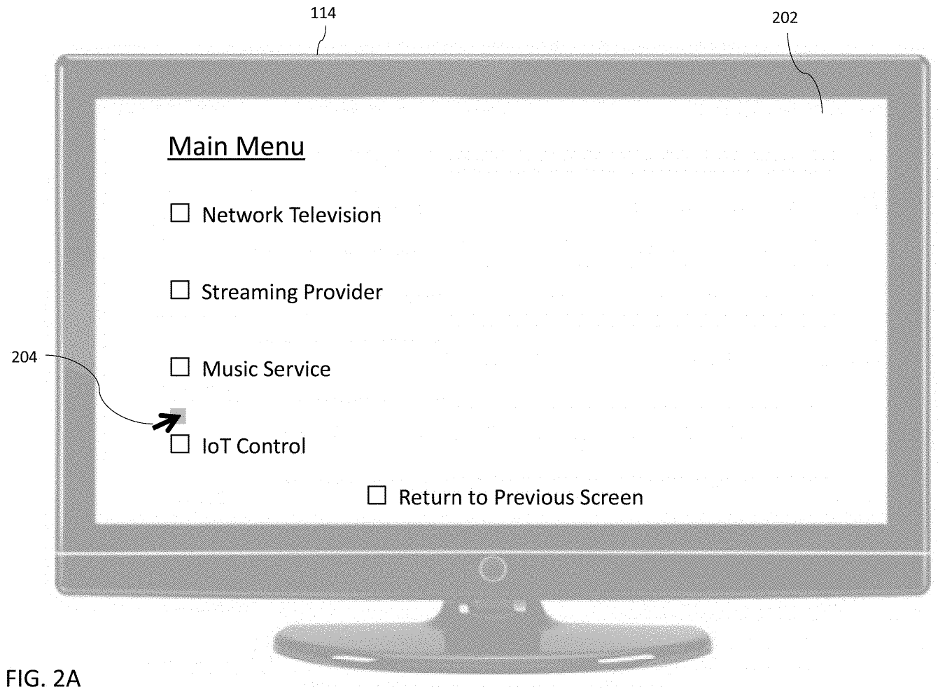

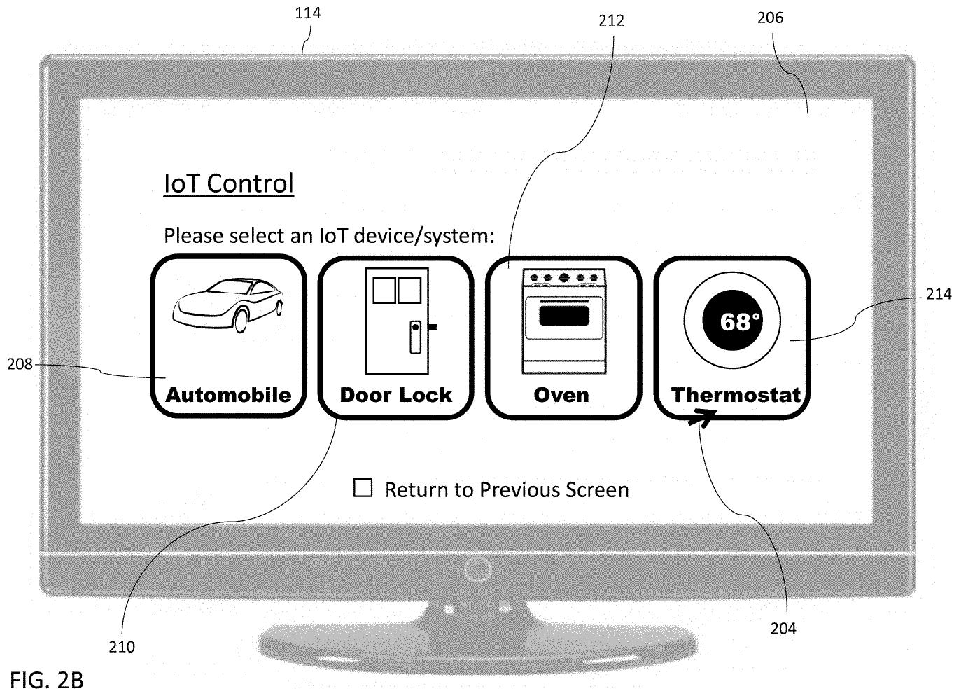

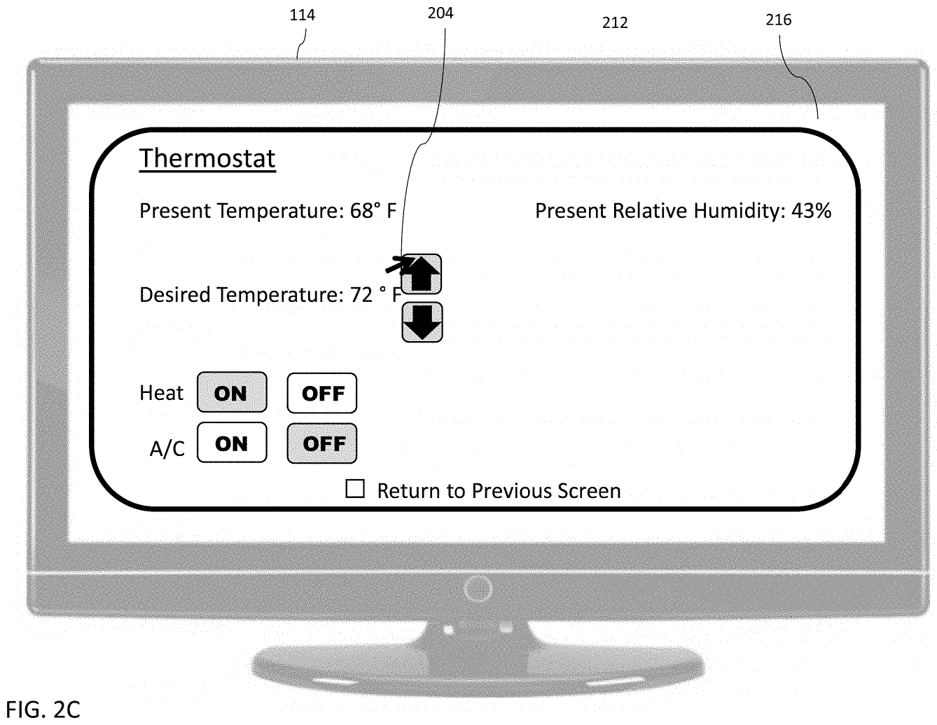

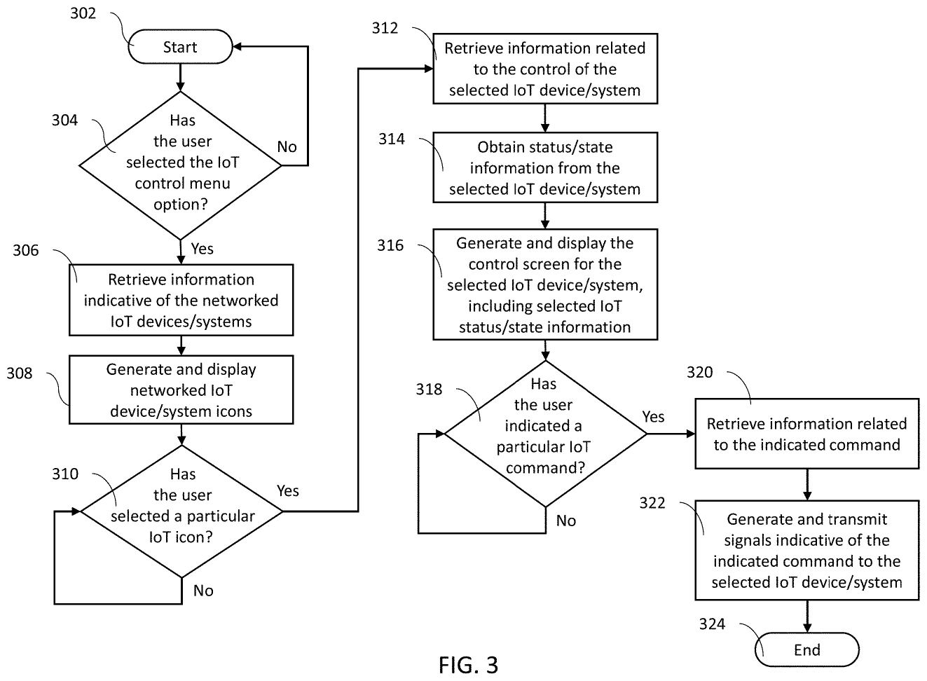

In system 100, a user (128) utilizes remote-control 130 to select the “IoT Control” function option from choices presented on a main menu. FIG. 2A depicts a main menu screen (202) displayed on television 114 that is generated by processor 104 from information retrieved from memory 106. As shown, cursor 204 has been position to select “IoT Control” from the various choices presented on the screen of television 114. This selection corresponds to steps 302 and 304 within the process depicted by the flow diagram of FIG. 3. In response, processor 104 retrieves the necessary information from memory 106 to enable the generation and display of a screen (206) comprised of four icons (208, 210, 212 and 214), each of which corresponds to a particular networked IoT device/system (steps 306 and 308 in FIG. 3). FIG. 2B provides an example of such a screen.

The user would then use remote-control 130 to manipulate cursor 204 to select a particular one of these icons (step 310). FIG. 2B depicts the situation where icon 214 has been selected (corresponds to the IoT system controlling thermostat 126. Processor 104 responds by retrieving information from memory 106 related to the generation of IoT control commands for thermostat 126 (step 312), obtains the status of thermostat 126 (current temperature stetting, enabled heating or cooling systems, etc.) (step 314), and utilizes the retrieved information to generate and display a command screen (step 316). FIG. 2C provides an illustration of a thermostat command screen (216).

The user can then manipulate cursor 204 to select a particular thermostat action or command (step 318). As shown in FIG. 2C, the user has selected the up arrow so as to increase the desired temperature of the room or area serviced by thermostat 126. With every “click” of the cursor on the up arrow, the desired temperature would be increased by one degree. In response to this increased temperature command action by the user, processor 104 would retrieve information related to formulating a command to instruct thermostat 126 to increase the desired temperature to 72° F. from memory 106 (step 320). And the appropriate command would be generated by processor 104 and communicated to thermostat 126 via wireless network 116 (step 322). The process then terminates with step 324.

Not depicted in FIG. 3 is the process that recognizes a user choosing the “Return to Previous Screen” option. This conditional was omitted from the process described above and shown in FIG. 3 for the sake of clarity. It will be understood that if a user were to manipulate on-screen cursor 204 to select that option on any of the screens shown in FIGS. 2A-C, processor 104 would retrieve the appropriate information from memory 106 so as to provide the user with a display of the previously viewed screen.

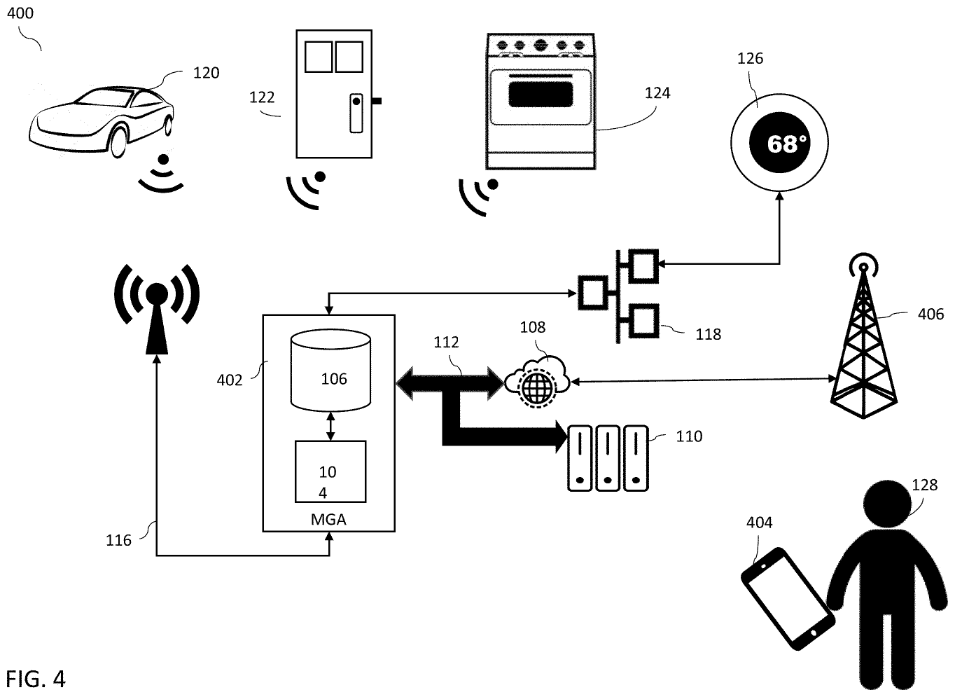

FIG. 4 provides a diagram of a system (400) that supports an alternate embodiment of the invention. System 400 shares many common elements with system 100, and like components have been numbered in the same manner as FIG. 1. However, unlike MGA 102 of system 100, MGA 402 is not shown to be linked to a television, and MGA 402 lacks a wireless receiver adapted to receive remote-control signals. MGA 402 is also shown to be linked to a cellular network (406) via the Internet (108) and broadband link 112. In addition, user 128 is shown to be utilizing smartphone 404 as a means of interacting with IoT systems 120, 122, 124 and 126.

The operation of system 400 is quite similar to that of system 100; the steps shown in the flow diagram of FIG. 3 are executed. The difference being that the graphical interface is the touch-screen of smartphone 404. User 128 selects screens, receives information and executes commands via the smartphone. The link between smartphone 404 and MGA 402 can be accomplished via cellular network 406, or via a local wireless link (such as Bluetooth®) to wireless network 116.

Although the invention herein has been described with reference to particular embodiments, it is to be understood that these embodiments are merely illustrative of the principles and applications of the present invention. For example, the device utilized to interface with the MGA could be any device capable of accepting user commands and providing a graphical display, including, but not limited to, tablets, computing systems, digital assistants, etc. Furthermore, any of the links or connections described as being wireless could be accomplished via wired means. The converse holds true for any links or connections described as being wired—They could be accomplished via wireless means without departing from the scope of the disclosed invention. Additionally, the IoT systems that could be controlled via the disclosed technology are in no way limited to those specifically referenced above, nor are the commands that could be communicated to the media systems limited to those mentioned above. The controlled systems could include household appliance systems, entertainment systems, security systems, environmental systems, cleaning systems, maintenance systems, agricultural systems, transportation systems, communication systems, etc. It will also be understood that although the processors and memories depicted in the particular embodiments discussed above were described as being contained within or collocated with an MGA, the processing and storage functionality associated with these components could be provided by remotely located devices, systems or other assets, linked to the MGA via a public or private network. All of the above variations and reasonable extensions therefrom could be implemented and practiced without departing from the spirit and scope of the present invention as defined by the appended claims.

1. A system for enabling the control of a plurality of internet-of-things systems, the system comprising:
at least one local network;
a plurality of internet-of-things systems linked to the at least one local network;
at least one memory adapted to store information indicative of each of the networked internet-of-things system comprising information interpret information received from and generate control commands intended for each of the networked internet-of-things systems;
a user interface;
a display; and
at least one processor adapted to:
generate upon the display, in response to at least a first user command received via the user interface, a first list comprising the plurality of internet-of-things systems, wherein the first list is based, at least in part, on the stored information;
generate upon the display, in response to a user selecting, via the user interface, a particular one of the plurality of internet-of-things systems from the first list, a second list comprising at least one command executable upon the selected particular one of the plurality internet-of-things systems, wherein the second list is based, at least in part, on the stored information; and
transmit to the selected particular one of the plurality of internet-of-things systems, in response to a user selecting, via the user interface, at least one command from the second list, information enabling the execution of the selected at least one command by the elected particular one of the plurality of internet-of-things systems.

2. The system of claim 1 wherein the user interface is linked to the at least one processor by at least one of the following:
a local wireless network;
a Wi-Fi network;
a Bluetooth link;
an optical link;
an ultrasonic link;
an Ethernet network; and
a cellular network.

3. The system of claim 1 wherein the first list comprises a plurality of icons.

4. The system of claim 1 wherein the at least one processor is further adapted to:
receive status information from each of the plurality of internet-of-things systems; and
generate upon the display, in response to the user selecting a particular one of the plurality of internet-of-things systems from the first list, an indication of the status of the selected particular one of the plurality internet-of-things systems.

5. The system of claim 1 wherein the display comprises at least one of the following:
a television;
a smartphone;
a tablet; and
a computer monitor.

6. The system of claim 1 wherein the user interface comprises at least one of the following:
a touch screen; and
a remote-control device.

7. The system of claim 1 wherein the local network comprises at least one of the following:
a wireless network; and
a wired network.

8. The system of claim 1 wherein at least one of the plurality of internet-of-things systems comprises at least one of the following:
A household appliance system;
an entertainment system;
a security system;
an environmental system;
a cleaning system;
a maintenance system;
an agricultural system;
a transportation system; and
a communication system.

9. The system of claim 1 wherein the system for enabling the control of a plurality of internet-of-things systems comprises a media gateway appliance.

10. The system of claim 9 wherein the media gateway appliance comprises a set-top box.

11. A method for enabling the control of a plurality of internet-of-things systems, in a system comprising:
at least one local network;
a plurality of internet-of-things systems linked to the at least one local network;
at least one memory adapted to store information indicative of each of the networked internet-of-things system comprising information interpret information received from and generate control commands intended for each of the networked internet-of-things systems;
a user interface; and
a display;
the method comprising the steps of:
generating upon the display, in response to at least a first user command received via the user interface, a first list comprising the plurality of internet-of-things systems, wherein the first list is based, at least in part, on the stored information;
generating upon the display, in response to a user selecting, via the user interface, a particular one of the plurality of internet-of-things systems from the first list, a second list comprising at least one command executable upon the selected particular one of the plurality internet-of-things systems, wherein the second list is based, at least in part, on the stored information; and
transmitting to the selected particular one of the plurality of internet-of-things systems, in response to a user selecting, via the user interface, at least one command from the second list, information enabling the execution of the selected at least one command by the elected particular one of the plurality of internet-of-things systems.

12. The method of claim 11 wherein the user interface is linked to the at least one processor by at least one of the following:
a local wireless network;
a Wi-Fi network;
a Bluetooth link;
an optical link;
an ultrasonic link;
an Ethernet network; and
a cellular network.

13. The method of claim 11 wherein the first list comprises a plurality of icons.

14. The method of claim 11, further comprising the steps of:
receiving status information from each of the plurality of internet-of-things systems; and
generating upon the display, in response to the user selecting a particular one of the plurality of internet-of-things systems from the first list, an indication of the status of the selected particular one of the plurality internet-of-things systems.

15. The method of claim 11 wherein the display comprises at least one of the following:
a television;
a smartphone;
a tablet; and
a computer monitor.

16. The method of claim 11 wherein the user interface comprises at least one of the following:
a touch screen; and
a remote-control device.

17. The method of claim 11 wherein the local network comprises at least one of the following:
a wireless network; and
a wired network.

18. The s method of claim 11 wherein at least one of the plurality of internet-of-things systems comprises at least one of the following:
A household appliance system;
an entertainment system;
a security system;
an environmental system;
a cleaning system;
a maintenance system;
an agricultural system;
a transportation system; and
a communication system.

19. The method of claim 11 wherein the system for enabling the control of a plurality of internet-of-things systems comprises a media gateway appliance.

20. The method of claim 19 wherein the media gateway appliance comprises a set-top box.
